(19) United States
(12) Patent Application Publication
(10) Pub. No.: US 2014/0018084 A1
(43) Pub. Date: Jan. 16, 2014

(54) METHOD AND APPARATUS FOR ANTENNA PLACEMENT OF WIRELESS BASESTATIONS

(71) Applicant: Hitachi, Ltd., Tokyo (JP)

(72) Inventors: Yoshihito SATO, Hitachi (JP); Tsutomu YAMADA, Hitachinaka (JP); Kenjiro TAKATANI, Yokohama (JP)

(73) Assignee: Hitachi, Ltd., Tokyo (JP)

(21) Appl. No.: 13/930,171

(22) Filed: Jun. 28, 2013

(30) Foreign Application Priority Data
Jul. 9, 2012 (JP) 2012-153365

(51) Int. Cl. H04W 84/04

(52) U.S. Cl. CPC H04W 84/042
USPC 455/446

(57) ABSTRACT

Wireless basestations antenna placement, determining an indoor placement enabling utilization of a radio wave coming from the outside. A space in a construction is divided into regions where communication using a foreign wave can and cannot be performed, and an antenna installation position to ensure communication quality in the region where the communication cannot be performed, is determined. Included are: a request condition input unit specifying a required communication performance for where the wireless basestation antenna is to be installed, a basestation antenna placement unit determining a basestation antenna placement position, and a foreign wave use condition determination unit dividing the construction into regions where the required communication performance is and is not satisfied by the foreign wave. The wireless basestation antenna placement unit determines the placement position of the basestation antenna by considering the wireless basestation antenna in the region not satisfying the required communication performance.

### BACKGROUND OF THE INVENTION

1. Technical Field

The present invention relates to a method and apparatus for antenna placement of wireless basestations for cellular phones or the like.

2. Related Art

In recent years, traffic in a cellular phone network is increased by the rapid increase of smart phones and the like, and expansion of data communication capacity in the network is urgently required. Although installation of outdoor basestations is being almost completed, improvement in indoor radio wave propagation environment is required.

As background art of the technical field, there is Patent Literature 1 (JP-A-2004-304255). This disclosure relates to access point installation of a wireless LAN. The problem is “to provide a wireless LAN designing apparatus for easily determining the optimum placement of access points and clients by taking into account problems of the response of the clients and the radio wave interference”, and the solution is “to provide means for entering a building placement drawing of a place where a wireless LAN is installed on a computer screen; means for entering a radio wave transmissivity or a radio wave reflectance of a radio wave propagation obstacle; means for placing the access points and the clients; means for dividing the building placement drawing into areas if necessary and entering a communication performance condition; means for calculating the strength of a radio wave from each of the access points at a plurality of points on the building placement drawing on the basis of the placement of the access points and the clients, displaying a range in which a radio wave with a minimum radio wave strength from each of the access points reaches, and displaying areas in which the radio wave strength does not reach the minimum radio wave strength and areas in which the radio waves interfere with each other; and means for performing enhancement display of the clients who do not reach a minimum communication available speed by calculating the response time of each of the clients”.

Patent Literature 1 discloses to provide means for displaying the range in which the radio wave from the access point reaches, the range in which the radio wave does not reach, the areas in which the radio waves interfere with each other, and the clients who do not reach the communication speed. The placement of the access points is changed according to these displays, and the communication speed is obtained by overcoming the interference.

In the case of the wireless LAN as the object in Patent Literature 1, since other radio wave emission sources merely become interference sources, in order to avoid interference of these, it is necessary to change the frequency or to make the intensity of the radio wave stronger than those of the radio waves of the interference sources.

However, in the case of the cellular phone as the object in the invention, although radio waves entering from the outside can become interference sources of the same frequency channel, they are also simultaneously radio waves usable for communication. With respect to this point, in the technique of Patent Literature 1, since only the interference of the radio waves is problematic, these radio waves can not be used.

### SUMMARY OF INVENTION

The invention provides a method and apparatus for antenna placement of wireless basestations, in which an indoor placement to enable utilization of a radio wave coming from the outside is determined.

In order to solve the problem, the invention adopts, for example, the structure recited in the claims.

The invention includes a plurality of means for solving the problem, and one example thereof is “a method for antenna placement of wireless basestations including dividing a space in a construction into a region where communication using a foreign wave can be performed and a region where the communication can not be performed, and determining an installation position of a wireless basestation antenna to enable a required communication quality to be ensured in the region where the communication can not be performed”.

Besides, an apparatus for antenna placement of wireless basestations includes a request condition input unit configured to specify a required communication performance in a construction where a wireless basestation antenna is to be installed, a basestation antenna placement unit configured to determine a placement position of the wireless basestation antenna, and a foreign wave use condition determination unit configured to divide the construction into a region where the required communication performance is satisfied by a foreign wave and a region where the required communication performance is not satisfied, wherein the basestation antenna placement unit configured to determine the placement position of the basestation antenna considers placing the wireless basestation antenna in the region where the required communication performance is not satisfied.

According to the invention, there is an effect that not only the foreign wave coming from the outside is suppressed as an interference source and the indoor radio wave is used, but also the foreign wave is used as an indoor usable signal, and indoor required communication capacity can be ensured.

### BRIEF DESCRIPTION OF DRAWINGS

FIG. 1 is a view showing a structure of an apparatus for antenna placement of wireless basestations according to embodiment 1.

FIG. 2 is a view showing an example of a three-dimensional construction of a building where a wireless basestation antenna is to be placed.

FIG. 3 is a view showing an example of a table to store three-dimensional structure information expressed in coordinates.

FIG. 4 is a view showing an example of areas where request conditions are set in a building where a wireless basestation antenna is scheduled to be placed.

FIG. 5 is a view showing an example of a table for setting the request conditions.

FIG. 6 is a view showing an example of a foreign wave data table.

FIG. 7 is a view showing an example of evaluation points in the areas where the request conditions are set.

FIG. 8 is a view showing an example of a processing flow of a foreign wave use condition determination unit.

FIG. 9 is a view showing an example of a processing flow for determining whether the request conditions are satisfied by a foreign wave.

FIG. 10 is a flowchart for explaining a process of a wireless basestation antenna placement unit.

FIG. 11 is a view showing an example of candidate positions of a wireless basestation antenna.

FIG. 12 is a view showing an example in which an area of a construction is divided into areas.

FIG. 13 is a view showing a specific case for explaining a relation between a foreign wave condition and an area condition change.

FIG. 14 is a view showing an example of the finally determined placement positions of the wireless basestation antennas.

FIG. 15 is a view showing a communication quality after the wireless basestation antenna placement.

FIG. 16 is a view showing a structure of an apparatus for antenna placement of wireless basestations according to embodiment 2.

FIG. 17 is a view showing an example in which a construction, coming directions of foreign waves and distances are specified.

FIG. 18 is a view showing a processing flow of a measurement point determination unit.

### DESCRIPTION OF EMBODIMENTS

Hereinafter, embodiments will be described with reference to the drawings.

### Embodiment 1

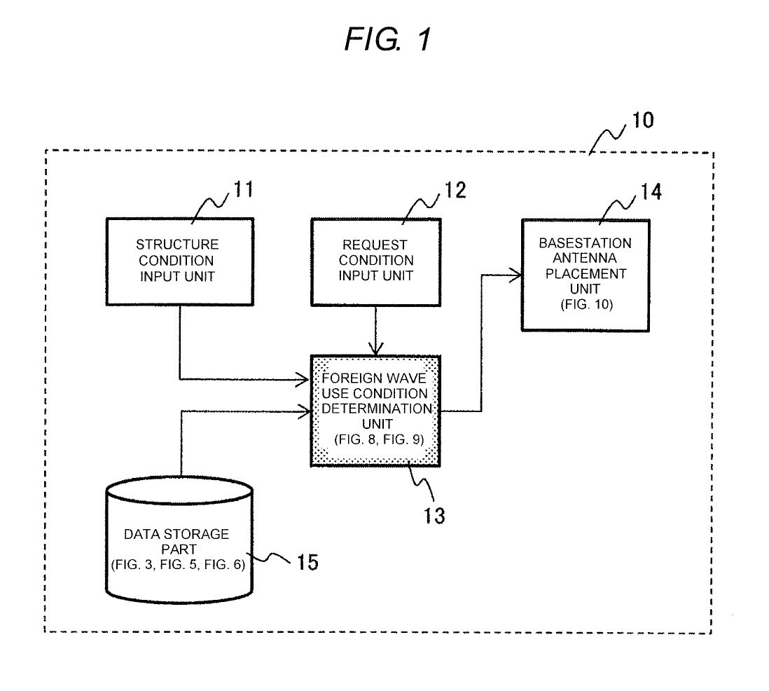

In this embodiment, an example of an apparatus 10 for antenna placement of wireless basestations will be described. FIG. 1 is an example of a structural view of the apparatus for antenna placement of wireless basestations according to this embodiment.

The apparatus 10 for antenna placement of wireless basestations includes a structure condition input unit 11, a request condition input unit 12, a foreign wave use condition determination unit 13, a basestation antenna placement unit 14 and a data storage part 15. Hereinafter, the structure of FIG. 1 will be described step by step in detail.

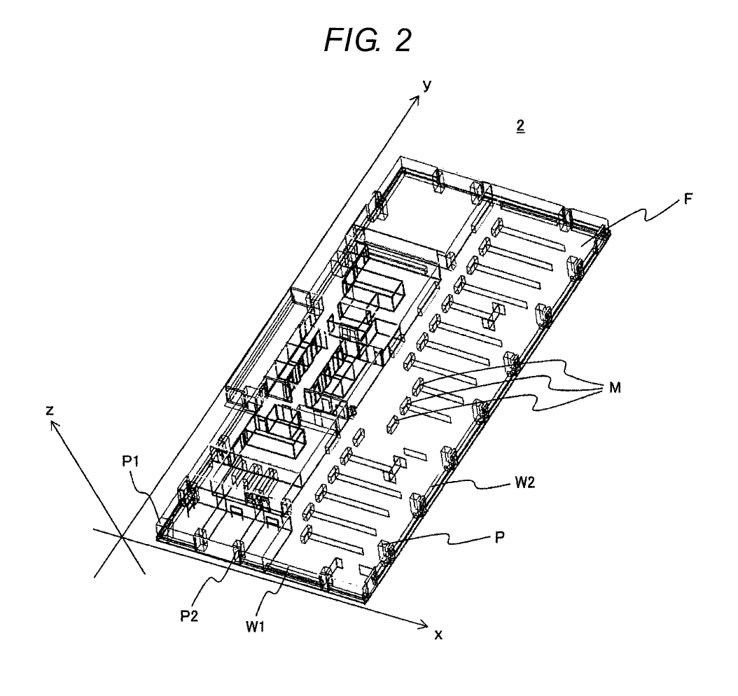

First, the structure condition input unit 11 inputs information of a three-dimensional construction of a building where wireless basestation antennas are to be placed. FIG. 2 shows an example of the three-dimensional construction 2 of the building. In the following description, a description will be made on a case where the wireless basestation antennas are placed in this construction 2.

The three-dimensional construction 2 of this case is, for example, a floor structure of a building or the like, and wireless basestation antennas are to be placed on this floor. The building is constructed of a wall surface W, a floor F, a ceiling, a window, a pillar P and the like. Further, structures, such as a machine M installed in a room separated by these and a fixture, also exist on the floor.

In the three-dimensional structure of the floor where a wireless network is to be configured, a placed position or the like is described in a previously defined three-dimensional coordinate system (X, Y, Z). For example, the left lower corner is made the origin of the three-dimensional coordinate system (X, Y, Z), and the positions of the structures, such as the wall surface W, the floor F, the ceiling, the window, the pillar P, the machine M installed in the room and the fixture, are previously defined.

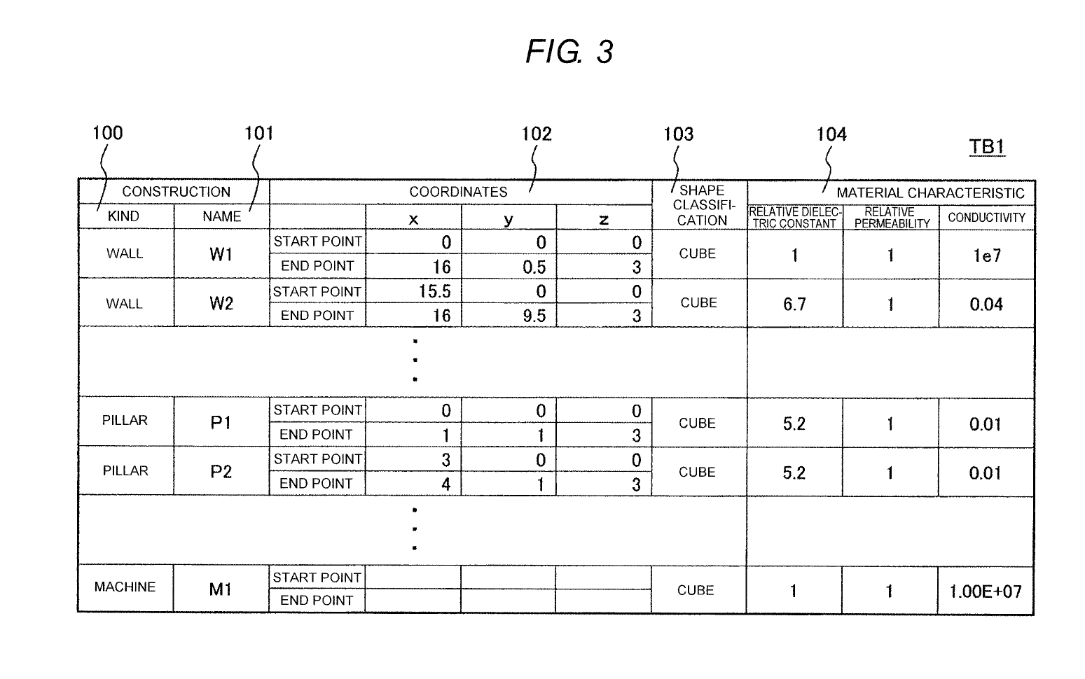

FIG. 3 shows an example of a table TB1 to store three-dimensional structure information expressed in the coordinates. The data is inputted from the structure condition input unit 11 of FIG. 1, and is stored in the data storage part 15. This stores information of a kind 100 of the structure, a name 101, a three-dimensional coordinate system (X, Y, Z) 102, a shape classification 103 and a material characteristic 104.

Incidentally, here, with respect to the structure, such as the wall or the pillar, in which the shape classification 103 is a cube, the three-dimensional structure information is expressed in the three-dimensional coordinate system (X, Y, Z) 102 in which coordinate positions of two diagonal points are specified. For example, when referring to the three-dimensional coordinate system (X, Y, Z) 102 of FIG. 3, the wall W1 of FIG. 2 has a cubic structure of a length of 16 m, a thickness of 0.5 m and a height of 3 m, in which the coordinates of the start point are (0, 0, 0), and those of the end point are (16, 0.5, 3).

Besides, the material characteristic 104 is indicated by values of relative dielectric constant, relative permeability, and conductivity [S/m] as the characteristic values of material constituting the wall W1. The values of the material characteristic 104 are not limited to these parameters as long as the characteristic values indicating reflectivity, transmittance, loss and the like of radio wave become clear.

Similarly, according to FIG. 3, the pillar P1 of FIG. 2 has a cubic structure of a length of 1 m, a thickness of 1 m and a height of 3 m, in which the coordinates of the start point are (0, 0, 0), and those of the endpoint are (1, 1, 3). Besides, the pillar P2 adjacent to the pillar P1 has a cubic structure of a length of 1 m, a thickness of 1 m and a height of 3 m, in which the coordinates of the start point are (3, 0, 0), and those of the end point are (4, 1, 3).

Incidentally, the structure condition input unit configured to input the three-dimensional structure information expressed in the coordinates may be such that an operator manually inputs through a keyboard or the like, or may be such that the unit is connected to another apparatus and these information is automatically obtained. For example, the unit is connected to a CAD (Computer Aided Design), and a CAD drawing may be used as the three-dimensional structure information. Besides, the unit is connected to a laser range scanner, a three-dimensional recognition camera or the like, and can also be used as an input apparatus of space information.

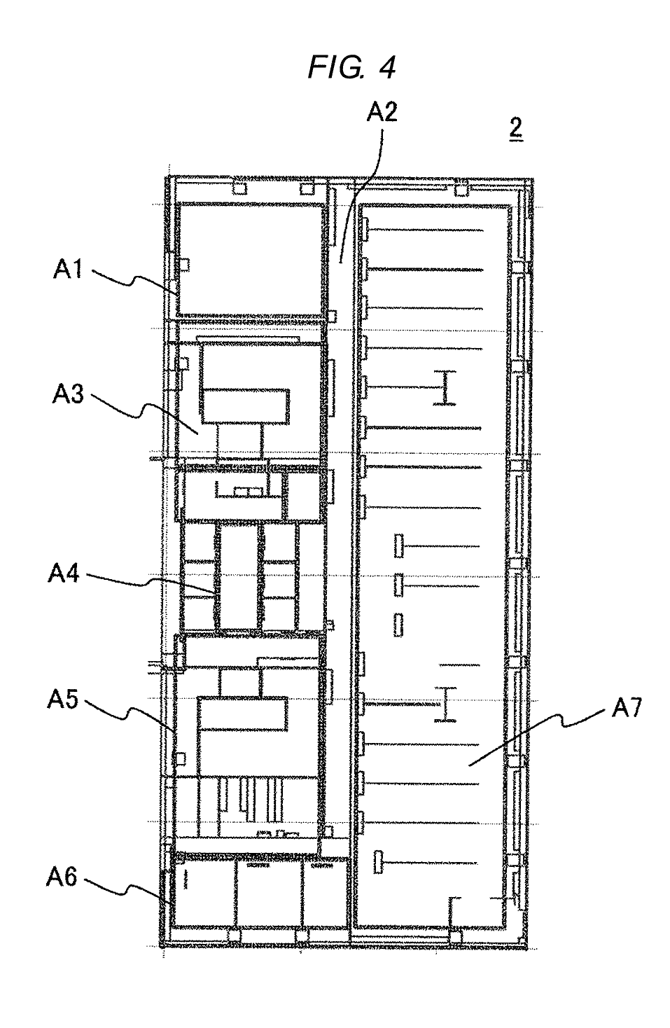

On the other hand, the request condition input unit 12 of FIG. 1 performs input of a request condition table TB2, definition of an evaluation point E position, and input of a foreign wave data table TB3. Hereinafter, although the contents of the tables TB2 and TB3 will be described, as the assumption, an example of an area where a request condition is set in a building where wireless basestation antennas are to be placed will be described with reference to FIG. 4.

FIG. 4 shows a planar placement view of the construction 2 of FIG. 2, and here, an area A means a space region such as a room.

The user uses the request condition input unit 12 and defines areas as indicated by A1 to A7 in the building where the wireless basestation antennas are to be placed. In the example of FIG. 4, a large room A7 of an office, a small meeting room A6, an executive room A1, a corridor A2 and a space region which is not separated, such as an elevator hole A4, are specified as the areas. The user sets the request condition for each of the areas A.

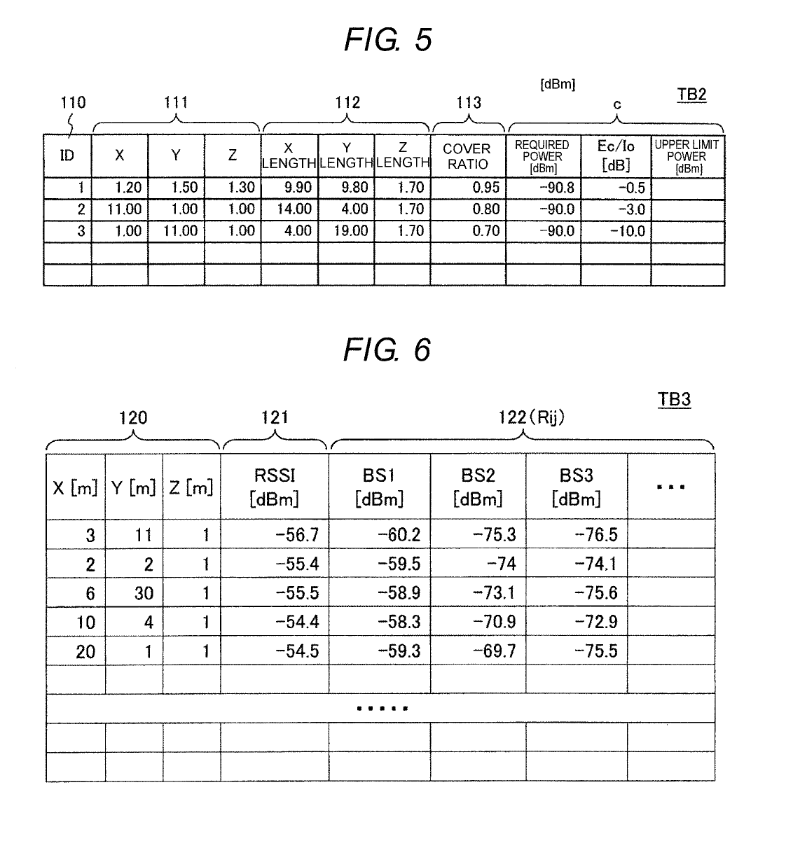

FIG. 5 shows an example of a table (request condition table TB2) to store the request conditions. The request condition table TB2 includes, for each ID 110 meaning an area, data of a set area place 111 (three-dimensional coordinate), a size 112, a cover ratio 113 and a request condition C. The request condition table TB2 of FIG. 5 shows an example in which the set area place 111 is represented by x, y, z coordinate values of an end point of the area A, and the size 112 of the set area is represented by respective lengths in the x, y, z coordinate axis directions.

For example, with respect to the place 111 and the size 112 of the registered area whose ID 110 is “1”, a position separated from the coordinate origin by 1.2 m in the X direction, 1.5 m in the Y direction, and 1.3 m in the Z direction (height) is made the endpoint (place), and when this point is made the reference, the size is defined as a space region (size) of 9.9 m in the X direction, 9.8 m in the Y direction, and 1.7 m in the Z direction (height).

In the area whose ID 110 is “1”, for example, the area A5 of the construction 2 of FIG. 4 is defined, and this setting is similarly performed for all the other areas using the different IDs 110. Incidentally, in addition to this, the area can be represented by a list of plural three-dimensional coordinate values, a spherical body or the like in order to define the region in the three-dimensional space.

Besides, in the request condition table TB2, the area cover ratio 113, and the request condition C including required power, Ec/Io and the like are specified for each of the areas. Here, the cover ratio is a value indicating the ratio of a range satisfying the request condition in the area. The cover ratio indicates that, for example, in the area of ID1, the request condition (required power, Ec/Io, etc.) is required to be satisfied in the space region of 0.95, that is, the ratio of 95% or more in the specified volume.

In the table TB2 shown in the example of FIG. 5, as the request condition C, for example, the required power and Ec/Io are adopted. Since these values vary according to a wireless system to be used, they are shown as an example. However, in the invention, the required power value and the index indicating the relation to the foreign wave are prerequisite. In brief, the request condition C indicates the factor relating to the communication quality, and another factor can be adopted.

Here, the required power Ec indicates the power value of a radio wave received from a wireless basestation and usable for communication, which is the minimum required to perform communication in a terminal existing in the specified area.

Ec/Io represents the ratio of the power value Ec usable for communication to the whole power value Io of received waves including a wireless radio wave from a communication desired basestation and a wireless radio wave from other basestations or a radio wave from a different wireless system. That is, Ec/Io is the index indicating the degree of interference of the other radio wave with respect to the signal from the wireless basestation, which is desired to be received.

Besides, the request condition C includes an upper limit power. Although FIG. 5 does not show a specific value, the upper limit value of the power reaching to the area from a basestation to be installed is indicated.

The request condition table TB2 including the data inputted from the request condition input unit 12 is recorded in the data storage part 15 of FIG. 1. Besides, foreign wave data is inputted from the request condition input unit 12, and the foreign wave data table TB3 is formed and is stored in the data storage part 15.

FIG. 6 shows an example of the foreign wave data table TB3 in which the foreign wave data is arranged. The foreign wave data indicates a received power of a radio wave transmitted from an existing basestation in the same wireless system as the basestation to be installed, or a received power of a radio wave in a different wireless system or in the same frequency channel of a random noise in the building construction 2 in which the basestation is to be placed.

The foreign wave data table TB3 includes an entire received power RSSI (Received Signal Strength Indication) 121 in coordinates (x, y, z) 120 of a point in an area A and received power values 122 of wireless radio waves from other basestations BS1, BS2 and BS3. Incidentally, although only three other basestations are shown in the example of FIG. 6, actually, there is a case where three or more stations exist, or the number of stations varies according to the coordinates. If there is a different between the sum value of the received powers of the respective basestations and the entire received power RSSI, there is a received power from another wireless system or a random noise.

In the foreign wave data table TB3, it is assumed that the received power values of wireless radio waves due to foreign waves at main points are obtained by previous measurement in the construction 2. That is, the communication qualities at the respective points of the construction obtained by the foreign waves are previously obtained.

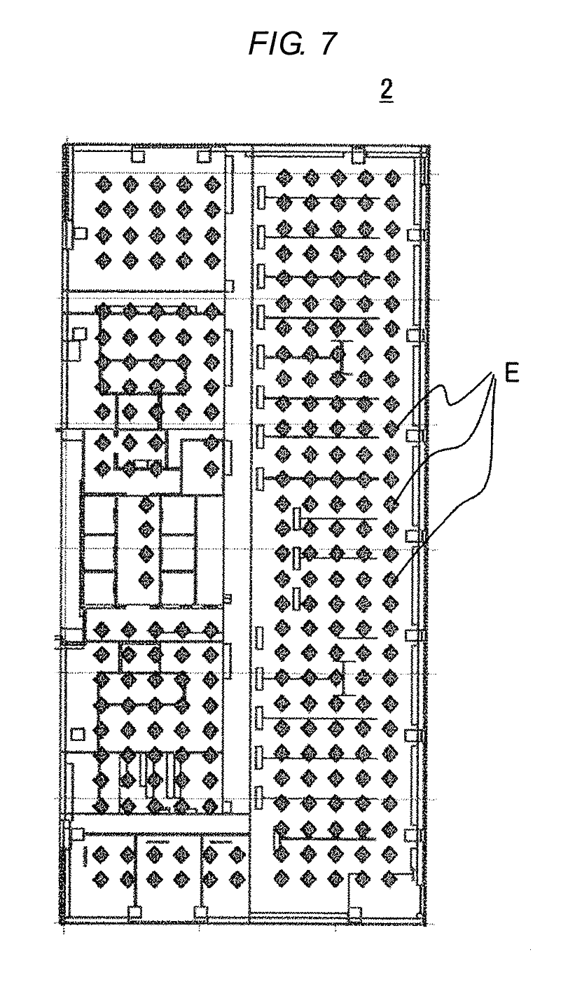

Besides, the evaluation points E of the respective areas A are inputted from the request condition input unit 12 of FIG. 1, and are stored in the data storage part 110. FIG. 7 shows the evaluation points E of the respective areas A. The evaluation points E indicate point sequences distributed in the areas A defined by the request condition input unit 12. The foreign wave data table TB3 is defined for the respective evaluation points E. Thus, the coordinates (x, y, z) 120 of a point in the area A of FIG. 6 represent the position of each evaluation point E.

Each evaluation point E can be treated as a divided area with a small volume. That is, in the request condition setting table TB2 of FIG. 5, each area A is represented by the position 111, the size 112 in the respective axial directions, and the request condition C. In the foreign wave data table TB3 of FIG. 6, the evaluation point E can be regarded as an area which has a small size, the request cover ratio 113 of 100% and the same request condition C as the original area. When the original area is made a parent area, the cover ratio of the evaluation point E as the small area can be made the cover ratio of the parent area. At this time, it is assumed that volumes occupied by the respective evaluation points do not overlap with each other in the same parent area.

The foreign wave use condition determination unit 13 of FIG. 1 uses the foreign wave data table TB3 and the request condition table TB2, generates the evaluation points E in the areas of the request condition table TB2, compares the data of the foreign wave data table TB3 at the respective evaluation points E with the data of the request condition table TB2, and determines whether the request condition C relating to the communication quality is satisfied at the evaluation points E in the respective areas A.

Further, when the area size occupied by the evaluation points E satisfying the request condition C in each area A exceeds a specified size, a process is performed in which the area is divided, and areas are newly added as areas satisfying the request condition.

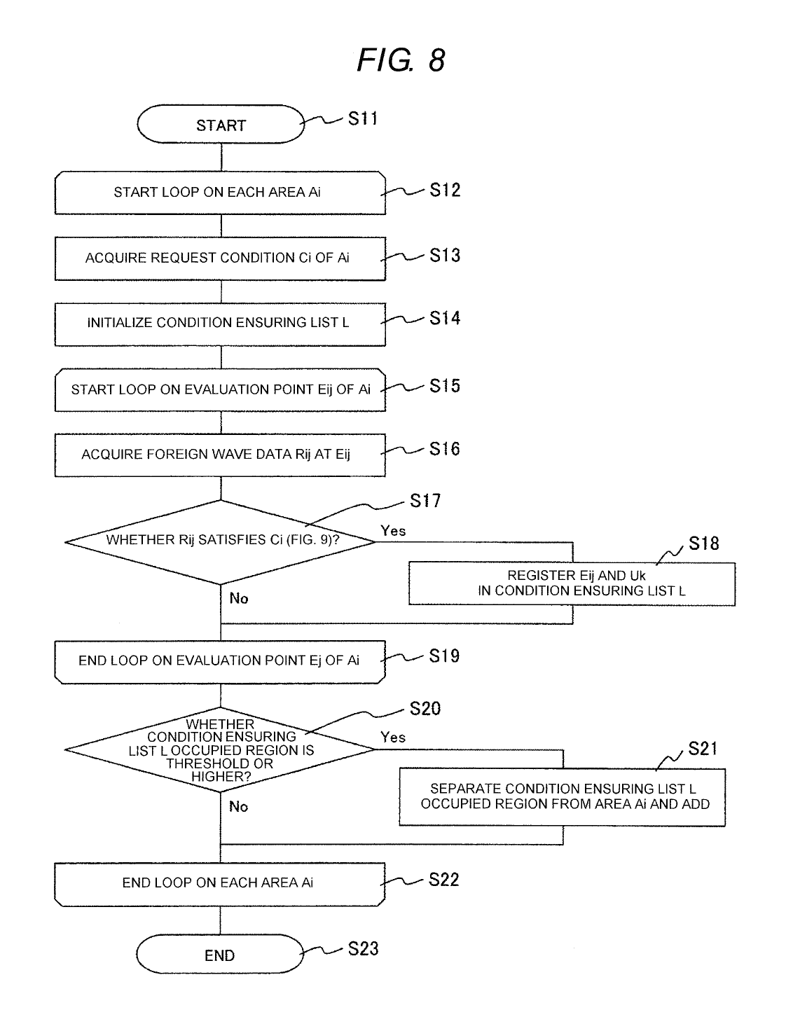

FIG. 8 shows a processing flow of the foreign wave use condition determination unit 13. The processing flow includes steps from step S11 to step S23. Step S11 indicates the start of the process. Step S12 indicates that a loop process is performed for each area Ai (ID 110 meaning the area) included in the request condition table TB 2 of FIG. 5, and the process until step S22 is repeatedly processed for each area Ai.

Step S13 is the step of acquiring the request condition Ci corresponding to the area Ai by referring to the request condition table TB2 of FIG. 5. As described before, the request condition Ci includes the request received power value, Ec/Io and the like in the area Ai.

Step S14 indicates a process of initializing a condition ensuring list L. The condition ensuring list L is list data in which plural combinations of the evaluation point E and the upper limit power can be stored.

Step S15 indicates that the process until step S19 is repeatedly processed with respect to each evaluation point Eij in the area Ai. Step S16 indicates a process of reading the entry of the foreign wave data Rij at the evaluation point Eij from the column 122 (received power values of wireless radio waves from the other basestations BS1, BS2, BS3) of the foreign wave data table TB3. Incidentally, if there is no entry at the same coordinate point in the foreign wave data table TB3, one or plural pieces of foreign wave data at near coordinate points are retrieved, and interpolation can be performed according to the distance.

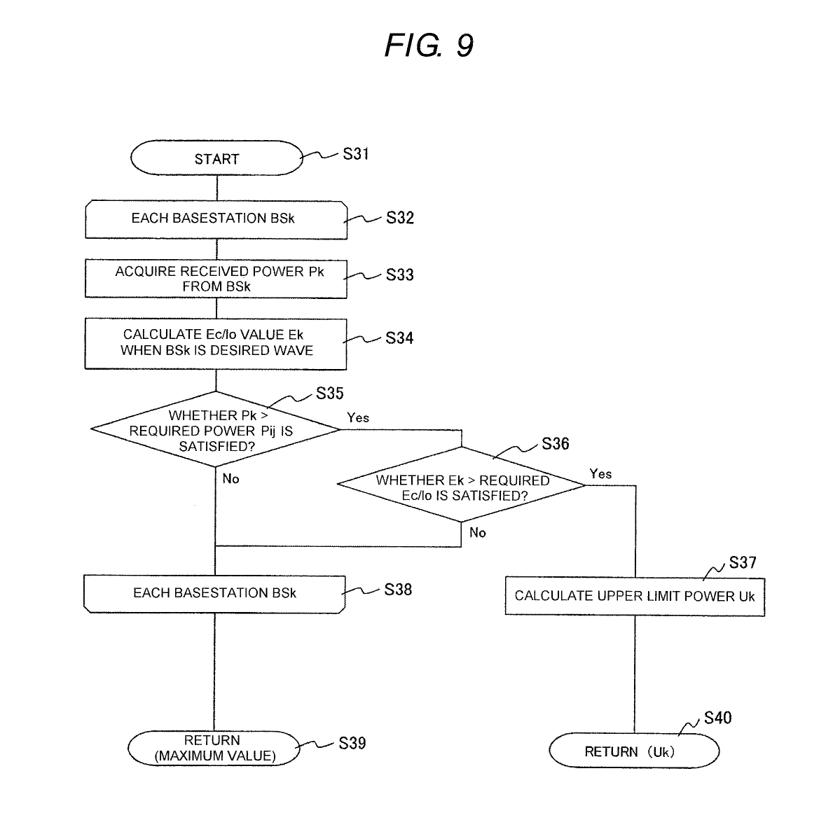

Step S17 indicates a process of determining whether the foreign wave data Rij satisfies the request condition Ci. This can be determined by, for example, an after-described processing flow shown in FIG. 9. When the condition is satisfied (Yes), the process of step S18 is performed, and then, advance is made to the process of step S19. When the condition is not satisfied (No), advance is directly made to the process of step S19.

Step S18 indicates the process performed when the condition is satisfied in the determination. If the condition is satisfied, the process of registering the evaluation point Eij and the upper limit power Uk into the condition ensuring list L.

Step S19 indicates the end of the loop process at step S15. The step indicates that return is made to step S15 in order to perform the process of the next evaluation point Eij. If the loops relating to all the evaluation points Eij are ended, advance is made to step S20.

Step S20 is the process of determining whether the region occupied by the evaluation point Eij registered in the condition ensuring list L is not less than a threshold. If the condition is satisfied, after the process of step S21 is performed, advance is made to the process of step 22. If the condition is not satisfied, advance is directly made to the process of step S22. As the occupied region, the total size of the evaluation points registered in the condition ensuring list L can be used.

Step S21 indicates a process of dividing the occupied region of the evaluation point registered in the condition ensuring list L from the area Ai and newly registering it as an area. The area is newly added to the request condition table, and the pair of the evaluation point registered in the condition ensuring list L and the upper limit power are added as the evaluation point included in the area.

Step S22 indicates the end of the loop process at step S12 and indicates returning to step S12 in order to advance to the process of a next area. If the loop relating to all the areas is ended, advance is made to the process of step S23.

Step S23 indicates the end of the process.

As described above, the foreign wave use condition determination unit 13 provides the unit configured to divide the area based on the foreign wave data Rij and to divide the area satisfying the request condition by the foreign wave from the area not satisfying.

FIG. 9 shows a specific flow of the determination process at step S17 of FIG. 8.

In FIG. 9, step S31 indicates the start of the process. Step S32 indicates that the process after step S34 is repeatedly performed with respect to each existing basestation Bk and the foreign wave reaching the evaluation point.

At step S33, received power Pk capable of being received from the existing basestation Bk is obtained from the foreign wave data table TB3. For example, with respect to the evaluation point expressed by the point of X=3, Y=11, Z=1 of FIG. 6, the received power Pk capable of being received from the existing basestation BS1 is “−60.2 dBm”. Similarly, the received power Pk capable of being received from the existing basestation BS2 is “−75.3 dBm”.

At step S34, a calculation is made to obtain a value Ek of Ec/Io when the radio wave from the existing basestation Bk is received as a desired wave.

Step S35 is the process of determining whether the received power Pk satisfies the required power Pij. If satisfied, the process of step S36 is performed, and if not satisfied, advance is made to the process of step S38.

Step S36 is the process of determining whether Ek satisfies the request condition Ec/Io. If satisfied, advance is made to the process of step S37, and the repeated process of step S32 to step S38 is ended.

Step S38 indicates the end of the loop process started from step S32. If there is no basestation, advance is made to the process of step S39, and if not so, return is made to step S32 and the repeated process of a next basestation is performed.

At step S37, a calculation is made to obtain the upper limit power Uk of the power P for satisfying the request Ec/Io when the power P, which causes interference, is further given to the received power Pk.

Step S39 indicates the final process when the existing basestation satisfying the request condition does not exist. In this case, as the upper limit power, the maximum value of the system is returned.

Step S40 indicates the final process when the existing basestation satisfying the request condition exists, and the calculated upper limit power Uk is returned.

The basestation antenna placement unit 14 is the unit configured to determine the basestation antenna placement satisfying the request condition in accordance with the request condition for each area. If the upper limit power is set at the evaluation point, the placement is determined so that the power from a new basestation does not exceed the upper limit power. If not so, the process of determining the placement is performed so as to satisfy the required power and Ec/Io.

For example, as disclosed in JP-A-2000-333239, a method of searching an optimum combination from candidates of many basestation positions by using GA (Genetic Algorithm) or the like can be used.

By the series of processes shown in FIG. 8 and FIG. 9, the foreign wave use condition determination unit 13 divides the area based on the foreign wave data Rij, and divides the area satisfying the request condition by the foreign wave from the area not satisfying.

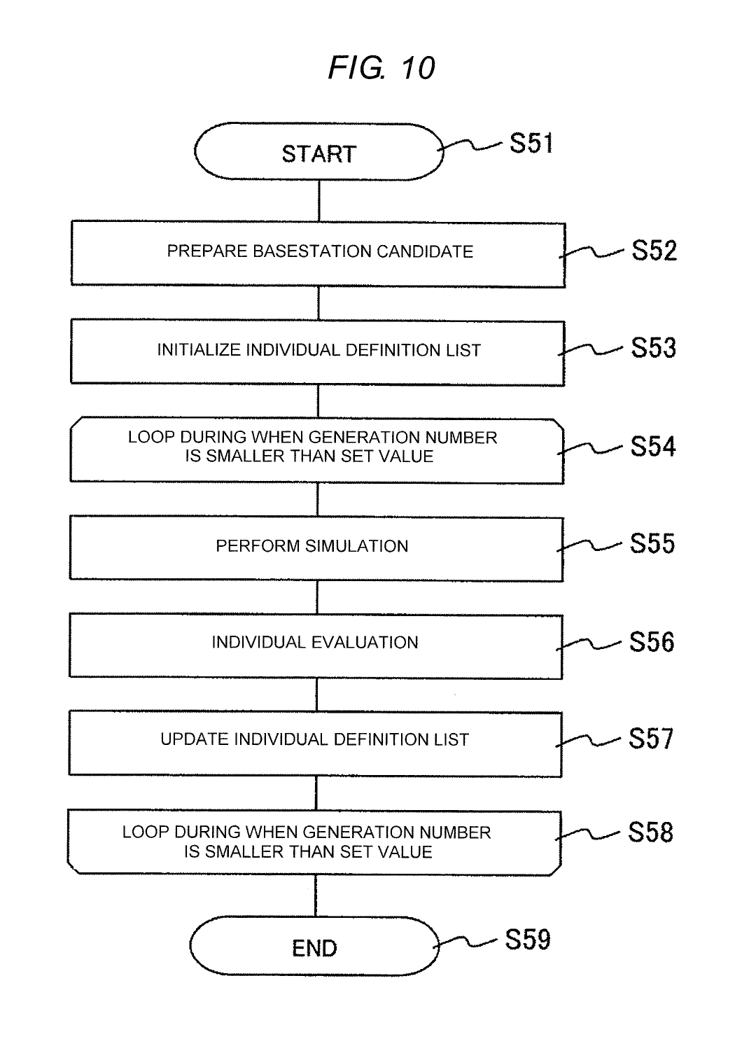

FIG. 10 shows a processing flow of the basestation antenna placement unit 14.

Step S51 indicates the start of the process.

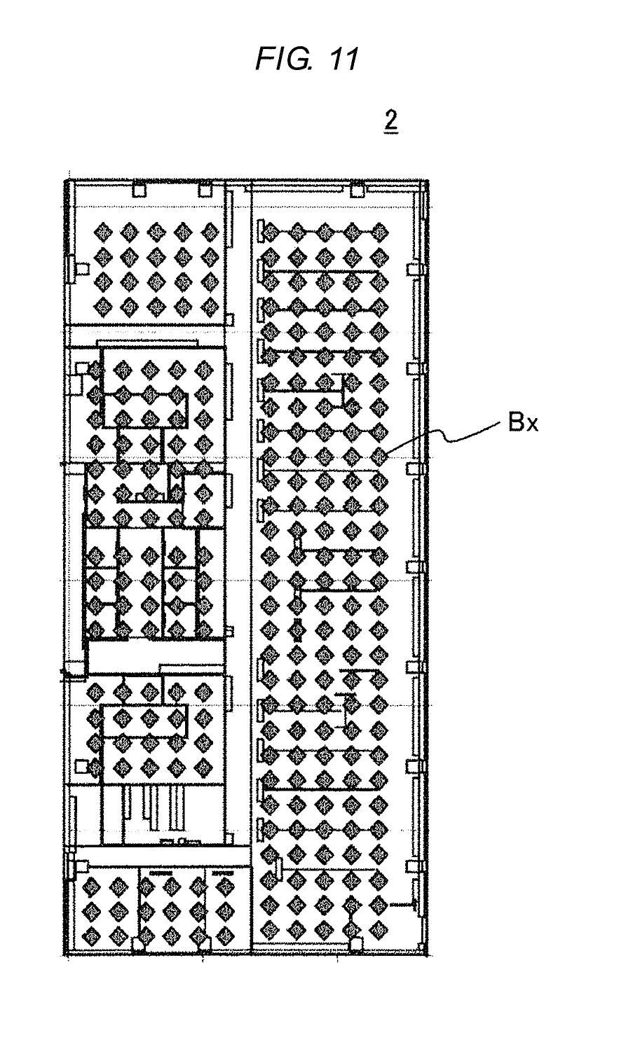

Step S52 indicates a process of generating basestation candidate positions. For example, as shown in FIG. 11, a method of uniformly setting basestation candidate positions Bx in each area, or a random generating method can be used.

Step S53 indicates a process of initializing an individual definition in the genetic algorithm GA. The individual represents a combination of basestation candidate positions, and further, transmission power at each basestation position, type of an antenna to be used, direction of the antenna and the like are defined as search parameters. Plural such individuals are generated and are stored in an individual definition list.

Step S54 indicates that the process is repeated by the number of set generations.

Step S55 indicates a process of extracting the individuals stored in the individual definition list one by one and estimating received power reaching an evaluation point by performing a radio wave propagation simulation based on the basestation position, transmission power and antenna setting included in the individual. Although various methods can be used as the radio wave propagation simulation, in the invention, a ray trace method is used as an example.

At step S56, an individual evaluation process is performed. This indicates the process of evaluating whether each individual included in the individual definition list satisfies the request condition for the area. On the basis of the received power reaching each evaluation point, if the upper limit power is defined for the evaluation point, it is evaluated whether the received power is not larger than the upper limit power. If the required power is not larger than the upper limit power, among the processes of FIG. 9, the processes of step S34 to step S37 are performed for the basestation of the individual, and instead of the process of step S37, as one satisfying the condition, a contribution is made to an area cover ratio.

This is repeated, and the evaluation value of the individual can be determined by increasing the evaluation value of the individual according to the area cover ratio, by decreasing the evaluation value as the number of basestations becomes large, or by decreasing the evaluation point value as the transmission power becomes high.

At step S57, a genetic operation such as crossover or mutation is applied to an individual having a high individual evaluation value in accordance with the individual evaluation result. A set of new individuals generated as a result thereof is an individual definition list.

Further, at step S58, the processes of step S55 to step S57 are repeatedly performed for individuals included in the new individual definition list until the final generation.

Step S59 indicates the end of the process.

By performing the process as stated above, the evaluation is performed on many individuals, and the individual having the highest evaluation is outputted. The individual having the highest evaluation indicates that the position is optimum as the candidate of the wireless basestation to be installed in the area.

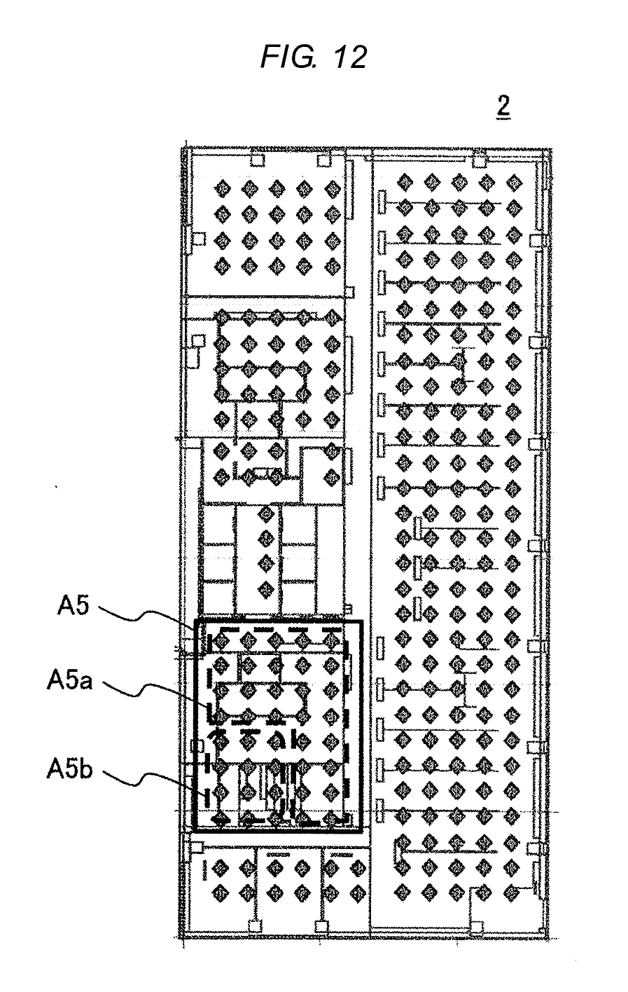

FIG. 12 shows an example in which the area A5 of the construction 2 is divided into areas A5a and A5b based on the foreign wave data Rij.

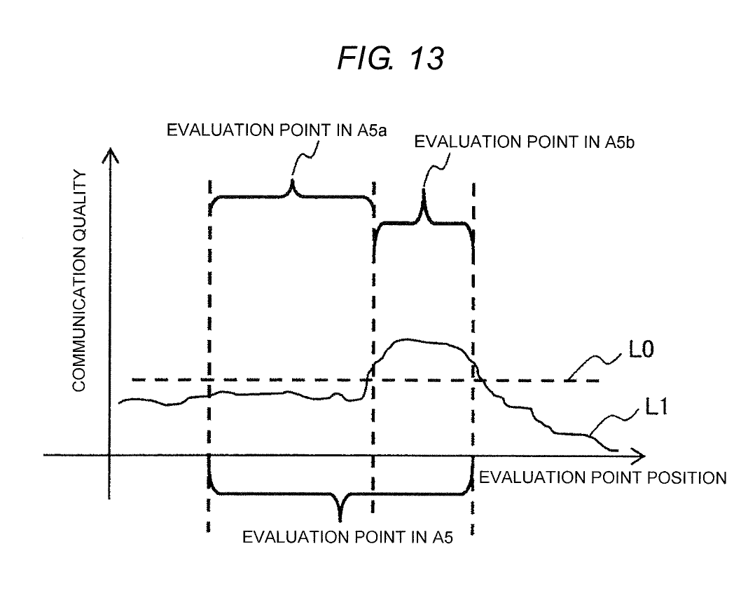

FIG. 13 is a view showing a specific case for explaining a relation between a foreign wave condition and an area condition change.

Circumstances leading to the area division will be described by use of FIG. 12 and FIG. 13. First, in the graph of FIG. 13, the horizontal axis indicates an evaluation point position in the area A5 of the construction 2 of FIG. 12. The vertical axis indicates a communication quality at each evaluation point. The horizontal axis is consequently divided into two regions. The right side indicates evaluation points in A5b, and the left side indicates evaluation points in A5a.

The communication quality by the foreign wave at each evaluation point varies according to the place, and as a result of measurement, the communication quality is represented by L1. The required communication quality level compared with this is L0 of a constant value, L1≧L0 is established at the evaluation point in the right side A5b, and L1<L0 is established at the evaluation point in the left side A5a.

In this case, each of A5a and A5b indicates a set of evaluation points obtained by dividing the evaluation points in the area A5. The division condition is that the communication quality level L1 by the foreign wave exceeds the request quality level L0, and the exceeding region exceeds a certain square measure. The exceeding square measure is suitably specified by the user.

Incidentally, the same condition as that of the original area A5 is defined as the request condition. However, since the evaluation point in the area A5b satisfies the request condition by the foreign wave of the existing basestation, the value of the upper limit power is set. On the other hand, in the area A5a, since the foreign wave does not satisfy the request condition, the upper limit power is not set.

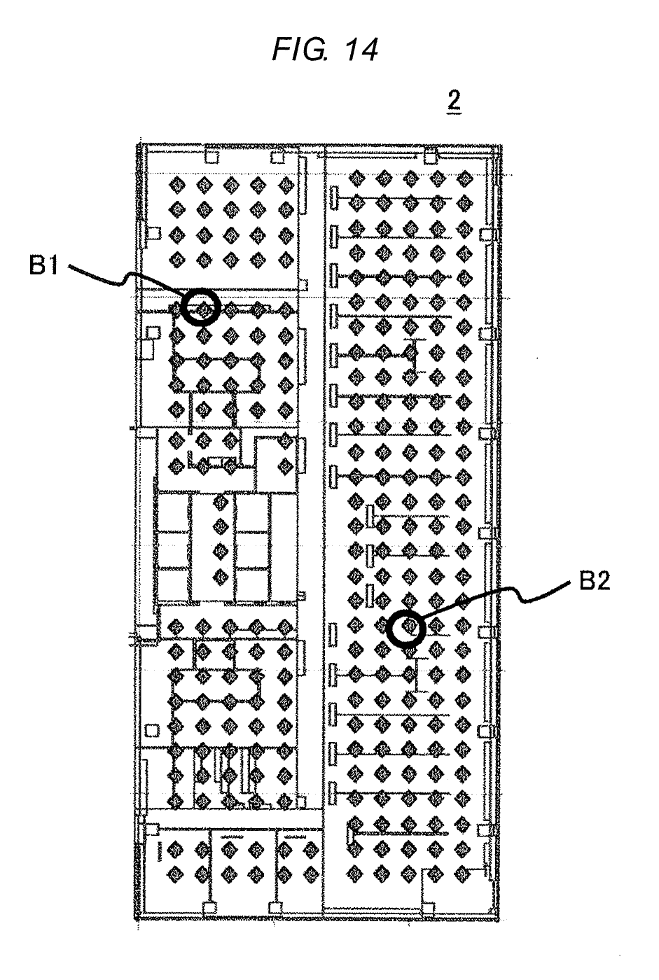

FIG. 14 is a view showing an example of a finally determined basestation antenna placement. Basestation antenna placement positions B1 and B2 are the center (B2) of the large room A7 and the end (B1) of the executive room A1, and are determined from the generated individuals satisfying the request condition.

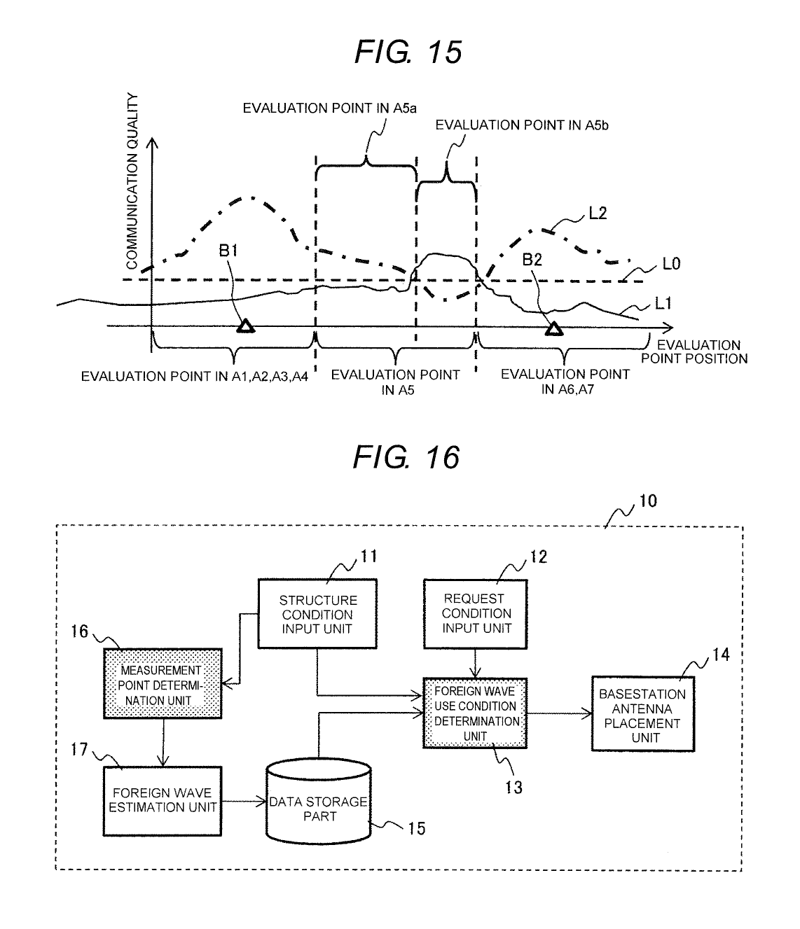

FIG. 15 is a view showing communication quality after the wireless basestation antenna placement. Similarly to FIG. 13, in this drawing, the horizontal axis indicates the evaluation point position in the construction 2, and the vertical axis indicates the communication quality at each evaluation point. However, the evaluation point position of the horizontal axis includes all the areas in addition to the area A5. The right side of the area A5 indicates the areas A6 and A7, and the left side of the area A5 indicates the areas A1, A2, A3 and A4.

According to the analysis result of FIG. 15, L1<L0 is established at the evaluation points of all the areas other than the area A5b. That is, the communication quality level L1 by the foreign wave exceeds the request quality level L0 only in the area A5b, and the exceeding region exceeds the specific square measure. Thus, the communication quality improvement by the wireless basestation antenna placement is not required for the area A5b, and the communication quality improvement by the wireless basestation antenna placement is indispensable for the other areas.

In FIG. 15, the evaluation is performed on many individuals by the process of the basestation antenna placement unit of FIG. 10, and each of the wireless basestations B1 and B2 is set at the individual position outputted as the individual having the highest evaluation. The individual having the highest evaluation is the position optimum as the candidate of the wireless basestation to be installed in the area, and the communication quality level improved after the wireless basestations are installed is indicated by L2. The improved communication quality level L2 is L2≧L0 at the evaluation points in all the areas other than the area A5b.

Incidentally, the improved communication quality level L2 in the area A5b is L2<L0, and the area does not receive the merit of the basestation installation (rather, the level is reduced). However, since the communication quality by the foreign wave is ensured from the beginning, the communication quality circumstances in the area A5b are not required to be considered in the individual evaluation.

In the invention described above, the results of the respective units are desirably suitably displayed on the display device. By this, the states of the respective tables in the data storage part 15, the communication state in the area in the process stage, the state of quality comparison, the improvement state and the like are made visually recognizable, so that the convenience of a placement position determining worker can be improved.

As a specific display for improving the convenience of the placement position determining worker, for example, it is desirable that the evaluation results at the evaluation points E in the construction of FIG. 7 are displayed in different colors so as to specify the region where communication using the foreign wave is possible and the region where the wireless basestation is required.

Further, in FIG. 14, the evaluation results at the evaluation points E after the wireless basestation is installed, together with the wireless basestation installation position, are desirably displayed in different colors. In this case, with respect to the region where communication using the foreign wave is possible, it is desirable that the region division is made, and the evaluation result of the foreign wave is displayed.

### Embodiment 2

In embodiment 2, a description will be made on an example of an apparatus for antenna placement of wireless basestations, in which measurement of foreign wave data can be performed at a small number of points.

FIG. 16 shows an example of a structural view showing a basestation antenna placement apparatus 10 of the embodiment 2. In the basestation antenna placement apparatus 10 of FIG. 16, portions having the same functions as those shown in FIG. 1 and described before are designated by the same reference numerals, and a description thereof is omitted.

The basestation antenna placement apparatus 10 of this embodiment includes a measurement point determination unit 16 and a foreign wave estimation unit 17 in addition to the basestation antenna placement apparatus 10 of FIG. 1.

Hereinafter, these units will be described below.

In the measurement point determination unit 16, three-dimensional structure data inputted by a structure condition input unit 11 is one of inputs. Besides, three-dimensional structure data of a building existing outside a construction 2 as an object for which basestation antenna placement is determined is also inputted when necessary.

Besides, evaluation point data distributed in respective areas, which is inputted by a request condition input unit 12 or is generated, is one of inputs. A coming direction of a foreign wave and a distance range can also be specified.

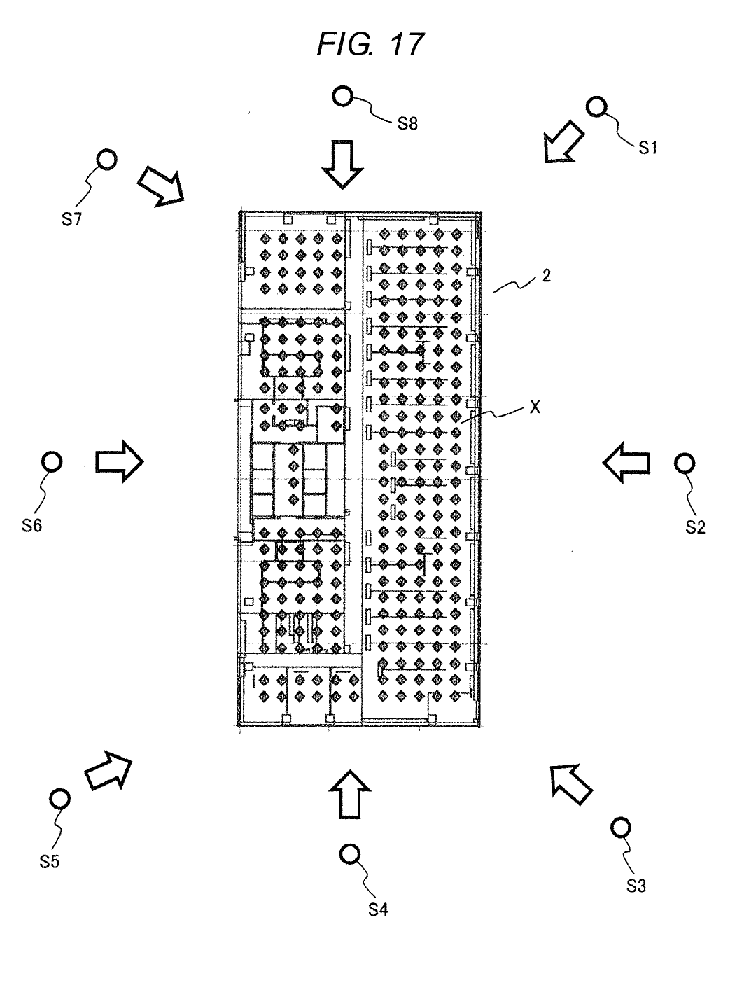

FIG. 17 shows an example in which a construction, coming directions of foreign waves, and distances are specified. Reference numeral 2 denotes the construction, and S1 to S8 denote transmission sources of the foreign waves. X denotes reception points defined in the construction, and points at which the intensities of the foreign waves propagating inside the construction are obtained.

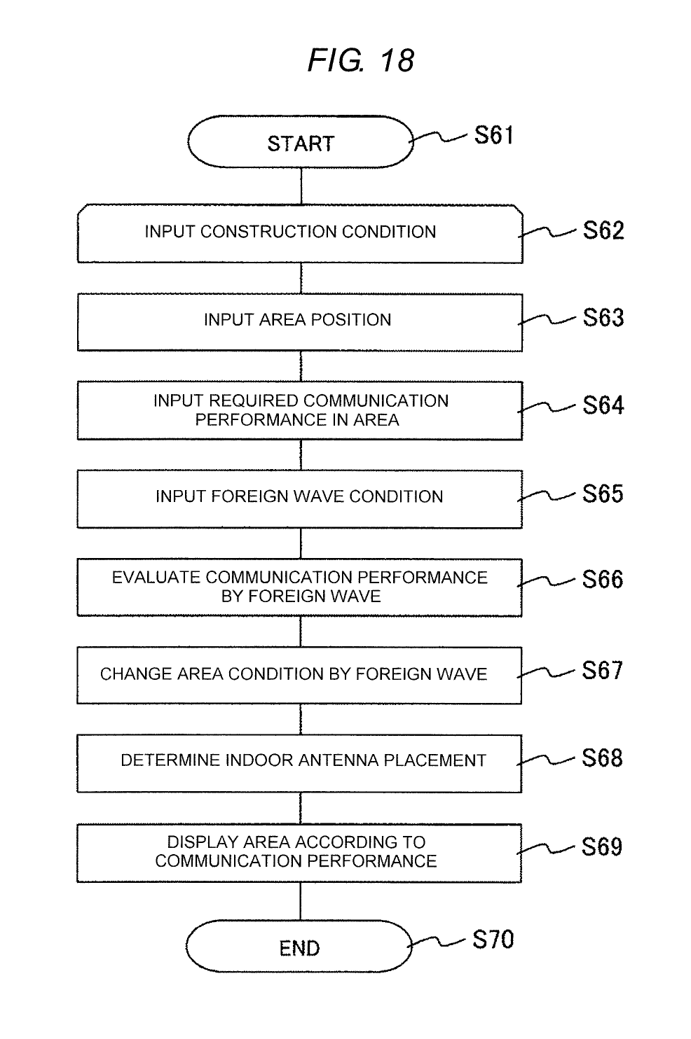

FIG. 18 shows a processing flow of the measurement point determination unit 16.

Step S61 indicates the start of the process.

Step S62 indicates that the process from step S63 to step S67 is repeatedly performed with respect to the coming angle of the specified foreign wave or the coming angle (θi generated at random) of the specified range.

Step S63 indicates that the process from step S64 to step S66 is repeated with respect to each specified distance or a distance Dj of a specified range.

At step S64, a transmission antenna Ak is defined with respect to the construction and with respect to the θi direction and the distance Dj.

Step S65 is a process of estimating radio wave propagation to Pk[x, y, z] when the transmission antenna Ak radiates a radio wave. The simulation process shown in FIG. 10 can be used for the estimation. Step S66 and step S67 respectively indicate the ends of the repeated processes of step S62 and step S63.

Step S68 indicates a process of performing a principal component analysis while θi and Dj at each Ak are object variables, and each value of Pk[x, y, z] is an explanatory variable Xk.

A principal component having a high contribution ratio can be extracted by the principal component analysis.

Further, Pk[x, y, z] having a large factor loading on the principal component having the high contribution ratio is extracted.

Further, narrowing is performed to obtain new Pk[x, y, z], the principal component analysis is again performed, and the principal component analysis is performed until the number of Pk[x, y, z] becomes a specified number or less.

In this way, a set of a specified number of Pk[x, y, z] is obtained.

The measurement determination unit 16 outputs these Pk [x, y, z].

The measurer measures the foreign wave at the positions of the extracted Pk[x, y, z] to obtain the antenna ID of the foreign wave and the value of the radio wave intensity, and inputs them into the foreign wave estimation unit 17.

The foreign wave estimation unit 17 estimates the coming angle 0 and the distance D for each antenna ID by using the principal component and from the obtained values.

The intensity of the foreign waves of each antenna ID reaching a point other than the measurement points can be estimated from these values.

From the above, the foreign wave in the whole construction can be estimated at a small number of measurement points.

What is claimed is:

1. A method for antenna placement of wireless basestations, comprising:
dividing a space in a construction into a region where communication using a foreign wave can be performed and a region where the communication can not be performed; and
determining an installation position of a wireless basestation antenna to enable a required communication quality to be ensured in the region where the communication can not be performed.

2. The method for antenna placement of wireless basestations according to claim 1, wherein the wireless basestations are wireless basestations for cellular phones.

3. The method for antenna placement of wireless basestations according to claim 1, wherein a plurality of evaluation points are set in the space in the construction, and the division of the regions is performed based on a set communication quality request and previously measured or estimated communication qualities of a foreign wave at positions of the evaluation points.

4. An apparatus for antenna placement of wireless basestations, comprising:
a request condition input unit configured to specify a required communication performance in a construction where a wireless basestation antenna is to be installed;
a basestation antenna placement unit configured to determine a placement position of the basestation antenna; and
a foreign wave use condition determination unit configured to divide the construction into a region where the required communication performance is satisfied by a foreign wave and a region where the required communication performance is not satisfied, wherein
the basestation antenna placement unit configured to determine the placement position of the basestation antenna considers placing the wireless basestation antenna in the region where the required communication performance is not satisfied.

5. The apparatus for antenna placement of wireless basestations according to claim 4, wherein
the request condition input unit generates evaluation points in an area determined in the construction,
and the apparatus further comprises
a measurement point determination unit configured to select a foreign wave measurement point for measuring the foreign wave from the evaluation points and from a structure condition of the construction, and
a foreign wave estimation unit configured to estimate foreign wave data at the evaluation point other than the foreign wave measurement point from foreign wave data obtained by actually measuring the foreign wave at the foreign wave measurement point.

6. The apparatus for antenna placement of wireless basestations according to claim 4, further comprising a display device, wherein evaluation results at the evaluation points in the construction are displayed in different colors on the display device, and a region where communication using the foreign wave is possible and a region where communication must use the wireless basestation antenna are specified.

7. The apparatus for antenna placement of wireless basestations according to claim 4, further comprising a display device, wherein evaluation results at the evaluation points after wireless basestation antenna installation, together with the wireless basestation antenna installation position, are displayed in different colors on the display device.
